(19) United States
(12) Patent Application Publication
(10) Pub. No.: US 2009/0152457 A1
(43) Pub. Date: Jun. 18, 2009

(54) Method for Analysis of a Solid Sample

(75) Inventors: Ewald Niehuis, Senden (DE); Reinhard Kersting, Münster (DE); Rudolf Möllers, Havixbeck (DE); Thomas Grehl, Münster (DE)

Correspondence Address: FAY KAPLUN & MARCIN, LLP, 150 BROADWAY, SUITE 702, NEW YORK, NY, 10038, US

(73) Assignee: ION-TOF GmbH

(21) Appl. No.: 11/917,664

(22) PCT Filed: May 19, 2006
(86) PCT No.: PCT/EP2006/004782

§ 371 Date: Jul. 31, 2008

(30) Foreign Application Priority Data
Jun. 16, 2005 (DE) 10 2005 027 937.6

(51) Int. Cl. B01D 59/44

(52) U.S. Cl. 250/282

(57) ABSTRACT

Described is a method for analysis of a solid sample and, in particular, for analysis of the material composition and distribution in or on a solid surface. The surface to be analysed is covered with caesium, at least partially and/or in regions, and the surface is irradiated with an analysis beam which contains predominantly or exclusively polyatomic ions with at least 3 atoms per ion. The secondary ions which are produced are then analysed on caesium compound.

The present invention relates to a method for analysis of a solid sample. Methods of this type are used in particular for analysis of material composition and distribution in or on a solid surface. They are likewise used in order to determine a depth distribution of the material composition of a solid (depth profile).

Various methods of secondary ion mass spectrometry (SIMS) have been established as suitable methods for analysis of solid surfaces. The sample surface to be analysed is hereby bombarded with an ion beam. This primary ion beam produces so-called secondary particles as a result of the impact cascade which takes place in the surface of the sample, said secondary particles being expelled from the surface (sputter process). However not only neutral secondary particles are produced thereby but also positively or negatively charged secondary ions. The secondary ions are then analysed subsequently with respect to their ratio of mass and charge. For this purpose, predominantly magnetic sector field appliances, quadrupole mass spectrometers or even time-of-flight mass spectrometers are used in secondary ion mass spectrometry. Analysis of the secondary ions which are produced can therefore be effected in different ways without the actual principle of the secondary ion mass spectrometry being affected thereby.

Various ion sources are available for producing the primary ion beam. Traditionally, gallium, caesium or oxygen ion sources are used.

Recently, also so-called cluster ion sources are used, which produce for example gold cluster ions or bismuth cluster ions. Such a cluster ion source was described and disclosed by the applicant of the present application in DE 103 39 346 A1 or in the published patent specification of PCT/EP 2004/007154. The liquid metal cluster ion sources described there are contained in their entirety in the disclosure of the present application. Furthermore, C60 molecules are already known from the literature as cluster ions for producing secondary ions.

These cluster ion sources have been used to date in the SIMS method in order to produce molecular secondary ions with a high yield in the case of organic sample surfaces.

However the actual SIMS method for analysis of solid compositions suffers from the so-called matrix effect. There is thereby understood that the secondary ion yield depends very greatly upon the chemical composition of the sample so that in general no direct correlation exists between signal intensity and concentration of an element M in the sample. The conventional SIMS method is therefore not suitable for precise quantitative analysis of a sample of an unknown composition. Standards with a very similar chemical composition are required for quantification.

Gao, Journal of Applied Physics 64 (7), 1999, pp. 3760 to 3762 therefore presents an alternative in this respect. In this method, the sample surface is sputtered with caesium ions, as a result of which a caesium covering is produced on the sample surface. Upon bombardment of such a surface with the primary ion beam, conventionally from a gallium ion source or in the radiation method also with the caesium source, the directly produced atomic secondary ions of the solid atoms M are now not detected but rather the emitted positively charged caesium compounds of these atoms CsM⁺ or Cs₂M⁺ (caesium cluster ions). Surprisingly, it resulted thereby that the signal intensity of the caesium cluster ions depends to a significantly lesser degree upon the chemical surroundings of the matrix than in the case of conventional SIMS methods. The matrix effect is therefore greatly suppressed in significance. This effect of the sputtering with caesium ions as primary beam, which is caused by covering the surface of the sample with caesium atoms or ions, has to date fundamentally not been able to be explained. The most current explanation which is however totally disputed is found in Magee et al., International Journal of Mass Spectrometry and Ion Processes, 103 (1999), pp. 45 to 56. Accordingly, during sputtering of a surface covered with caesium, a recombination of secondary neutral particles from the matrix with emitted caesium secondary ions is effected directly above the sample surface. The caesium cluster ions which are thus produced are then analysed. The physical-chemical mechanisms underlying this so-called MCs method would accordingly differ fundamentally from conventional SIMS methods.

In summary, it may be stated that the mechanism and the effect of the MCs method is not yet understood.

The present invention now has the object of indicating a method with which, with extensive reduction in matrix effect, a very high sensitivity of a secondary ion mass spectrometric method can be achieved.

This object is achieved by the method according to claim 1. Advantageous developments of the method according to the invention are given in the dependent claims.

In the case of the method according to the invention, the surface to be analysed is now covered with caesium atoms. This can also be effected merely in individual regions of the surface or only partially, i.e. without a closed caesium layer.

According to the invention, a primary ion analysis beam which contains predominantly so-called cluster ions is then used. All those ions which have at least three or more atoms per ion are designated here as cluster ions. There can be used for example Bi₃⁺, C60 or SF₅⁺ ions as such cluster ions.

It emerged now in a completely surprising way that the use of a cluster ion beam in the MCs method leads to a dramatic improvement in sensitivity i.e. in the ion yield. This effect could not be anticipated since, according to the above-described current model, the ion production mechanisms in the case of conventional SIMS methods and in the case of the MCs method are fundamentally different. Whilst in the SIMS method what is crucial in the real sense is the impact and ionisation ratios within the upper sample layers, it is accordingly the process of recombination above the surface which is crucial for the production of secondary ions in the MCs method.

The person skilled in the art was therefore not able to assume that the use of a cluster ion source in the MCs method would effect such dramatic improvements in sensitivity.

In a variant, a sputter ion beam is used in addition to the analysis ion beam in order to cover with caesium the surface to be analysed (two-beam method). An ion beam with caesium ions is used as sputter ion beam with which the surface of the sample to be analysed can be covered with caesium. This beam can be used in addition also during the depth profile analysis in order to achieve a removal of the surface.

Alternatively, the covering with caesium can also be effected by caesium vapour deposition of the sample.

The covering with caesium of the surface to be analysed by means of a Cs sputter beam or by vapour deposition with Cs can be effected before, during and/or intermittently with impingement of the surface with the possibly pulsed analysis beam.

In this way, the analysis function of the primary ion beam can be separated from the caesium coating by sputtering with a caesium beam or by vapour deposition with caesium.

The present invention is now suitable for a large number of analysis techniques and appliances, for example for magnetic sector field appliances, quadrupole mass spectrometers or also time-of-flight mass spectrometers. It is suitable in particular for increasing significantly the comparatively low sensitivity during analysis of inorganic solid bodies with the MCs method by means of the use according to the invention of a cluster primary ion source. Yield increases, for example from Ga⁺ to Bi₃⁺ or C₆₀⁺ up to a factor of 100 and more, are produced. This increase in yield improves the detection limits in secondary ion mass spectrometry by more than one order of magnitude. This is also the case when taking depth profiles.

If one considers the efforts which are made to increase the sensitivity of analytical measuring devices even by a few %, it can be seen that entirely new application fields are opened up for secondary ion mass spectrometry by means of the proposed invention.

In the following, a few examples of the method according to the invention are now described.

There are shown

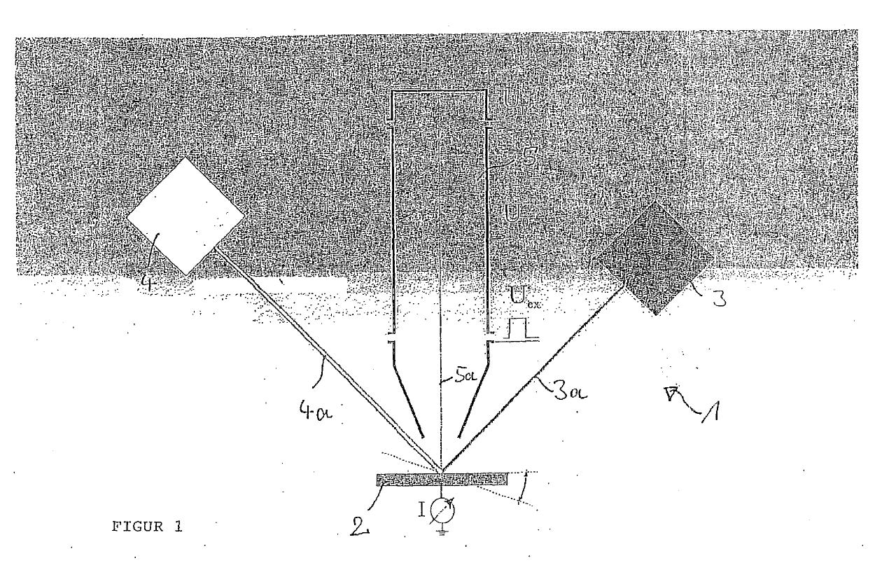

FIG. 1 the construction of a time-of-flight mass spectrometer (TOF-SIMS);

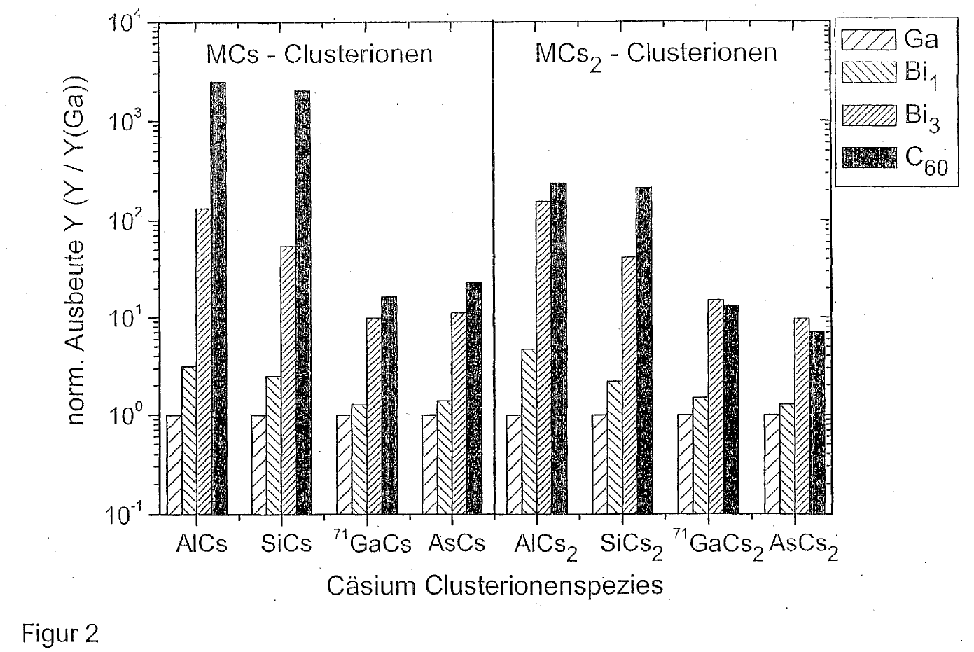

FIG. 2 yields of MCs and MCs₂ cluster ions upon bombardment of different solid samples (aluminium, silicon, gallium arsenide) with Ga⁺, Bi₁⁺, Bi₃⁺ and C₆₀⁺ after sputtering with caesium, standardised to the yield for Ga⁺;

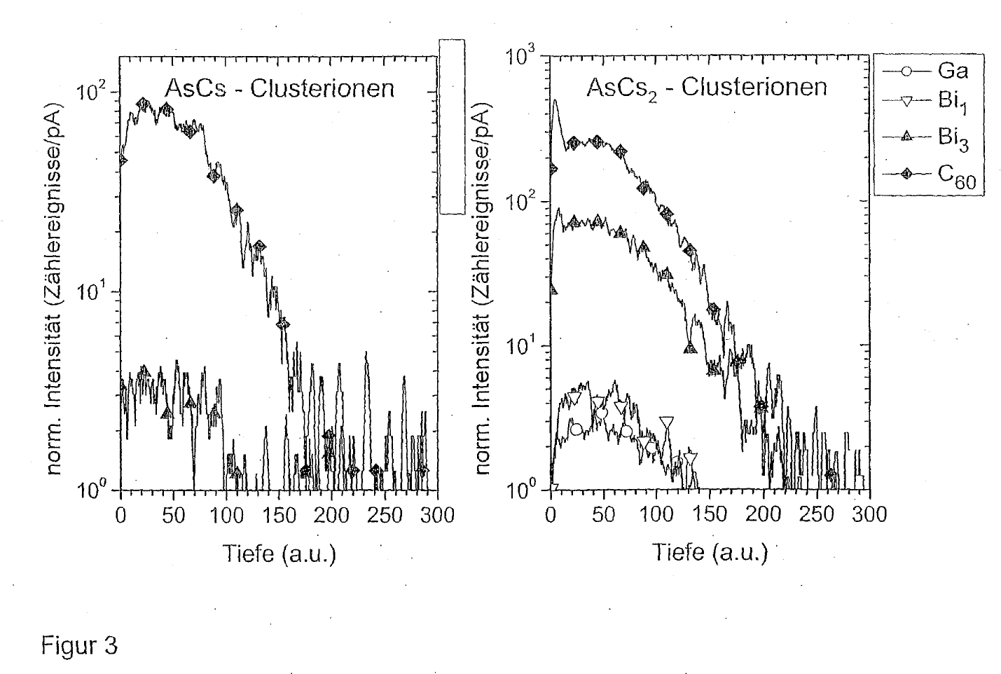

FIG. 3 depth profiles of an arsenic implantation in silicon, measured by means of the configuration of technical apparatus represented in FIG. 1, using Ga⁺, Bi₁⁺, Bi₃⁺ and C₆₀⁺ as analysis ions; and

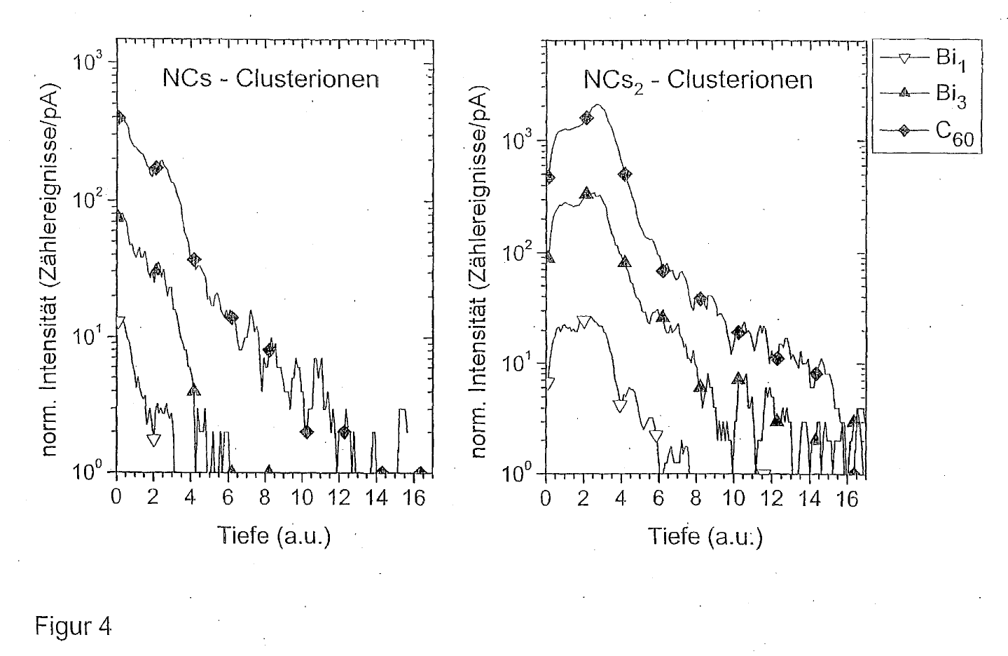

FIG. 4 depth profiles of a nitrogen distribution in a silicon dioxide sample, measured by means of the configuration of technical apparatus represented in FIG. 1, using Ga⁺, Bi₁⁺, Bi₃⁺ and C₆₀⁺ as analysis ions.

FIG. 1 shows a time-of-flight mass spectrometer 1 with a sample 2. A primary ion source 3 directs a primary ion beam 3a, which contains predominantly cluster ions, to the surface of the sample 2. Furthermore, a sputter ion source 4 directs a beam 4a comprising caesium ions towards the same point on the surface of the sample 2. The caesium beam 4a now covers the surface of the sample 2 with caesium atoms/ions and in addition leads to sputtering off of the surface of the sample 2. The analysis ion beam 3a, which is pulsed in time-of-flight spectrometers, produces an impact cascade within the surface 2 and expels neutral particles and ions from the surface of the sample 2. According to the above-described Magee model, the neutral particles now combine at least partially above the surface of the sample 2 with caesium ions which are produced by the beam 3a likewise in the region of the surface of the sample 2. The MCs⁺ or MCs₂⁺ molecules thus produced between the sample atoms M and the caesium ions are now subjected to a time-of-flight analysis, as is known from conventional time-of-flight mass spectrometers, and are analysed.

FIG. 2 shows the result of an analysis of three different solid samples, aluminium (M=Al), silicon (M=Si) and gallium arsenide (M=Ga and M=As). The samples were respectively sputtered with a caesium ion beam with an energy of 500 eV on a surface of 300×300 μm² until a constant covering with caesium was produced. The solid samples covered with caesium were analysed then in the centre of the sputter crater with an analysis beam comprising Ga⁺, Bi₁⁺, Bi₃⁺ with an energy of 25 keV and C₆₀⁺ with an energy of 10 keV. A time-of-flight mass spectrometer, TOF.SIMS 5 of ION-TOF GmbH, was used as mass spectrometer. The number of MCs⁺ secondary ions (AICs, SICs, GaCs, AsCs) and MCs₂⁺ secondary ions (AlCs₂, SiCs₂, GaCS₂, AsCs₂) respectively and the number of primary ions (Ga⁺, Bi₃⁺, Bi₃⁺ and C₆₀⁺) was determined. From the ratio of the number of secondary ions divided by the number of primary ions there is produced respectively the yield Y for the different secondary ion species MCs⁺ and MCs₂⁺. The yields for the primary ions Ga⁺, Bi₁⁺, Bi₃⁺ and C₆₀⁺ were standardised respectively to the yields with Ga⁺ (standardised yield Y/Y(Ga)). The bar diagram shows that, when using atomic primary ions with very different masses, such as Ga⁺ (m=69 u) and Bi₁⁺ (m=209 u), the yields of MCs⁺ cluster ions and MCs₂⁺ cluster ions differ only slightly. If however an analysis beam comprising cluster ions such as Bi₃⁺ and C₆₀⁺ is used, then increases in yield up to a factor of 100 and more are achieved (the logarithmic scale of the standardised yield Y/Y(Ga) should be noted). As a result of this dramatic increase in yields by using cluster primary ion sources, solid samples can now be analysed with significantly higher sensitivity and lower detection limits.

FIG. 3 shows the result of an analysis of a silicon sample in which arsenic was implanted. A quantitative analysis of such an arsenic depth distribution is of great importance for the semiconductor industry. For the measurement, a time-of-flight mass spectrometer, TOF.SIMS 5 of ION-TOF GmbH, was used in the two-beam method. The sample removal and the covering of the surface was effected respectively with a caesium ion beam with an energy of 500 eV on a surface of 300×300 μm². During this removal, the surface was analysed respectively in the centre of the sputter crater with Ga⁺, Bi₁⁺, Bi₃⁺ primary ions at an energy of 25 keV and C₆₀⁺ primary ions at an energy of 10 keV and the intensity of the AsCs⁺ cluster ions (left partial Figure) and AsCS₂⁺ cluster ions (right partial Figure) was determined for various depths. In order to convert respectively to an identical number of primary ions of the different species for each measuring point, the measured intensity was standardised to the primary ion flow in pA. When using Ga⁺ and Bi₁⁺, no AsCs⁺ cluster ions can be detected (no signal can be measured and observed in the left partial Figure of FIG. 3). With the cluster ions Bi₃⁺ and in particular C₆₀⁺, the depth distribution of arsenic can be measured by measurement of the AsCs⁺ cluster ions. Also during the analysis of AsCs₂⁺ as a measure of the depth distribution of the concentration of arsenic in the sample, a significant increase in intensity of up to a factor of 100 is observed (here also the logarithmic scale of the y axis should again be noted).

FIG. 4 shows the result of an analysis of a silicon oxide sample into which a small concentration of nitrogen was introduced close to the surface. A quantitative analysis of such a nitrogen depth distribution is of great importance for the semiconductor industry. For the measurement, a time-of-flight mass spectrometer, TOF.SIMS 5 of ION-TOF GmbH, was used in the two-beam method. The sample removal and the covering of the surface was effected respectively with a caesium ion beam with an energy of 500 eV on a surface of 300×300 μm². During this removal, the surface was analysed respectively in the centre of the sputter crater with Bi₁⁺ and Bi₃⁺ primary ions at an energy of 25 keV and C₆₀⁺ primary ions at an energy of 10 keV, and the intensity of the NCs⁺ cluster ions (left partial Figure) and NCS₂⁺ cluster ions (right partial Figure) was determined for the different depths. In order to convert respectively to an identical number of primary ions of the different species for each measuring point, the measured intensity was standardised to the primary ion flow in pA. With the cluster ions Bi₃⁺ and in particular C₆₀⁺, a significant increase in intensity by a factor of 10 and more (logarithmic scale!) can be achieved for the NCs⁺ cluster ions and NCs₂⁺ cluster ions.

1-9. (canceled)

10. A method for analysis of a solid sample using a secondary ion mass spectroscopy, comprising:
covering a surface of the sample to be analyzed one of at least partially and in regions with caesium;
irradiating the surface with an analysis beam to produce secondary ions, the analysis beam one of predominantly and exclusively containing polyatomic ions with at least three atoms per ion; and
analyzing the secondary ions on caesium compounds.

11. The method according to claim 10, wherein the analysis beam is produced by a liquid metal ion source.

12. The method according to claim 10, wherein the analysis beam includes one of monovalent and bivalent one of Biₙ and Auₙ ions where n is a natural number and at least 3.

13. The method according to claim 12, wherein the analysis beam includes at least one of Bi₃⁺ or Bi₃²⁺, SF₅⁺, and C60 ions.

14. The method according to claim 10, further comprising:
irradiating the surface with a sputter beam, the sputter beam including caesium one of predominantly and exclusively.

15. The method according to claim 13, wherein the surface is irradiated with the sputter beam one of before the analysis beam, during the analysis beam and intermittently with the irradiation by the analysis beam.

16. The method according to claim 10, further comprising:
vapour depositing caesium on the surface.

17. The method according to claim 15, wherein caesium is vapour deposited on the surface one of before, during and intermittently with the irradiation by the analysis beam.

18. The method according to claim 10, wherein the analysis of the secondary ions is effected in at least one of a magnetic sector field-mass spectrometer, a quadrupole-mass spectrometer and a time-of-flight mass spectrometer.

19. The method according to claim 10, further comprising:
detecting at least one of a mass spectrometric picture of the surface and a depth profile of the surface.
